(19) United States
(12) Patent Application Publication
(10) Pub. No.: US 2007/0274728 A1
(43) Pub. Date: Nov. 29, 2007

(54) OPTICAL COMMUNICATION SYSTEM AND METHOD USING OPTICAL CHANNELS WITH PAIR-WISE ORTHOGONAL RELATIONSHIP

(76) Inventors: Neal S. Bergano, Lincroft, NJ (US); Chien-Jen Chen, Hsin Chu (TW); Carl R. Davidson, Warren, NJ (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/420,607

(22) Filed: May 26, 2006

(51) Int. Cl. H04B 10/00

(52) U.S. Cl. 398/152

(57) ABSTRACT

An optical communication system and method may be configured to operate with optical signals having reduced channel spacing. The system may transmit optical signals on a plurality of optical channels with a pair-wise orthogonal relationship such that a first subset of channels has a first polarization state and a second subset of channels has a second polarization state. The channels may be spaced such that there is no overlap of modulation sidebands associated with channels in each of the polarization states. When receiving the optical signals, the orthogonal channels adjacent to a selected channel of interest may be nulled.

### TECHNICAL FIELD

The present application generally relates to optical communication systems that use wavelength division multiplexing (WDM) techniques, and more particularly, an optical communication system and method that uses optical channels with a pair-wise orthogonal relationship.

### BACKGROUND

Signal capacity of long-haul optical communication systems, such as “undersea” or “submarine” systems, has been increasing at a substantial rate over the last decade. For example, some long-haul optically amplified undersea communication systems are capable of transferring information at speeds of 10 gigabits per second (Gbps) or greater. Long-haul communication systems, however, are particularly susceptible to noise and pulse distortion given the relatively long distances over which the signals must travel (e.g., generally 600-12,000 kilometers). Because of these long distances, these systems require periodic amplification along the transmission path. In order to maximize the transmission capacity of an optical fiber network, a single fiber may carry multiple optical channels using a technique known as wavelength division multiplexing (WDM). For example, a single optical fiber might carry 32 individual optical signals at corresponding wavelengths, spread out in the low loss window of an optical fiber, for example, between about 1540 and 1564.8 nanometers (e.g., spread in channels on 0.8 nanometer centers). However, the signals launched into a transmission media undergo fiber nonlinearities, environmental factors, polarization mode dispersion that results in pulse broadening, channel overlap, distortion and noise accumulation, which contribute to reduction in signal to noise ratios.

For long-haul transmissions, high optical signal powers are used that induce phase shifts on the optical signal due to these fiber nonlinearities. The induced phase shifts correspond to wavelength modulation imposed on the optical signal. When different portions of an optical signal have different wavelengths, these different portions may propagate along the transmission fiber at different velocities due to dispersion properties inherent in the fiber media. After propagation for a distance, faster portions may overtake and become superimposed on slower portions causing amplitude distortion. In addition, four-wave mixing (“4WM”) is a nonlinear effect that causes a plurality of waves to interact and create a new wave at a particular frequency. This newly created wave may cause crosstalk when it interferes with other channels within the WDM channels.

Q-Factor is a measurement of the electrical signal-to-noise ratio (SNR) at a receive circuit in a communication system that describes the system's bit error rate (BER) performance. Q is inversely related to the BER that occurs when a bitstream propagates through the transmission path. The BER increases at low signal-to-noise ratios (SNRs) and decreases at high SNRs. A BER below a specified rate can be achieved by designing a transmission system to provide an SNR greater than a predetermined ratio. The predetermined SNR is based on the maximum specified BER. To achieve a low BER, the SNR must be high, and this may require the signal power to be at a level that induces undesired phase distortions due to fiber nonlinearities.

Electrical signal processing such as error correction and detection techniques may be used in communications systems to improve BER performance. Forward Error Correction (FEC) is one type of error correction that uses a redundancy code computed and inserted into the data stream at the transmitter end. At the receiver end, the data stream is processed to correct bit errors. While the need to transmit the FEC codes along with the data negatively impacts transmission capacity of the physical transmission channel by increasing the transmitted bit rate, the net performance of the transmission system is improved with the use of FEC techniques.

To counter the induced phase shift effects of high signal powers associated with fiber nonlinearities, a bit synchronous sinusoidal phase modulation is sometimes imparted to the optical signal at the transmitter to provide a chirped modulation format. One chirped modulation format is referred to as chirped RZ (CRZ). The inherent band spread of the CRZ waveform imposes a limit on how closely adjacent WDM channels may be spaced and subsequently the number of channels within a particular spectral band.

In order to increase the number of channels within the spectral band in view of these limitations, alternate optical channels may be transmitted in an orthogonal polarization relationship. This reduces the interactions (e.g., four wave mixing) and thus impairments between the channels. This technique has been used to demonstrate large spectral efficiency. However, to increase spectral efficiencies in WDM systems even more, optical channels are being placed closer together—thereby placing stringent requirements on how the signals are launched as well as how the signals are detected to maintain sufficient signal to noise ratios.

### BRIEF DESCRIPTION OF THE DRAWINGS

So the manner in which the above recited features of the present invention can be understood in detail, a more particular description of the invention, briefly summarized above, may be had by reference to embodiments, some of which are illustrated in the appended drawings. It is to be noted; however, the appended drawings illustrate only typical embodiments of this invention and are therefore not to be considered limiting of its scope, for the invention may admit to other equally effective embodiments.

FIG. 1 is a schematic diagram of a transmitter consistent with one exemplary embodiment of the present invention;

FIG. 2 is a graphical representation of optical channels with a pair-wise orthogonal polarization, consistent with one embodiment of the present invention;

FIG. 3 is a schematic diagram of a receiver including a system for nulling adjacent orthogonal channels, consistent with an embodiment of the present invention;

FIG. 4 is a schematic diagram of another embodiment of a system for nulling adjacent orthogonal channels; and

FIG. 5 is a graphical depiction of the relative intensity of optical channels where adjacent optical channels have been nulled.

### DETAILED DESCRIPTION

Capacity of optical communication systems can be improved by launching WDM channels with a pair-wise orthogonal relationship. By selecting channel spacings and polarization states between the channels, spectral efficiency can be improved thereby providing larger system capacity. When receiving the optical channels, channel selectivity may be improved by nulling orthogonal channels adjacent to a selected channel of interest.

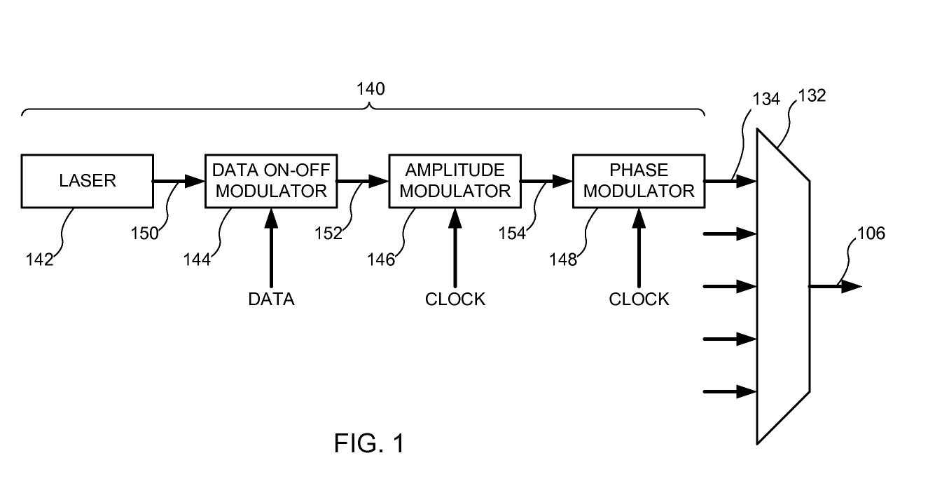

Referring to FIG. 1, there is illustrated one embodiment of a transmitter 140 consistent with the present invention. The illustrated exemplary embodiment includes a laser or light source 142, on-off data modulator 144, amplitude modulator 146 and phase modulator 148. The laser or light source 142 provides a coherent light signal 150 to the on-off data modulator 144, which provides an optical on-off data signal 152 to the amplitude modulator 146. The amplitude modulator 146 provides an amplitude modulated (AM) optical signal 154 to the phase modulator 148. The phase modulator 148 provides an output optical signal 134 to a transmission path 106 (e.g., an optical fiber) via a wavelength multiplexer 132.

The laser source 142 may provide the optical signal 150 at the nominal wavelength of the transmitter 140 (or some constant offset therefrom depending on the specific implementations of the modulators 144, 146 and 148). The amplitude modulator 146 may be configured to shape the power envelope of the optical signal 152 so as to provide a shaped optical signal 154. The amplitude modulator 146 may include shaping circuits that transform the clock signal input into a signal that drives the amplitude modulator 146 to achieve the desired shaped optical signal 154. The phase modulator 148 may respond to a clock signal input to generate a “chirped” output optical signal 134. The phase modulator 148 may impart an optical phase angle that is time varying, thereby imparting a frequency shift (and corresponding wavelength shift) to the output optical signal 134. The output optical signal 134 may be received by the multiplexer 132, multiplexed with other output optical signals at different wavelengths, and transmitted via the transmission path 106.

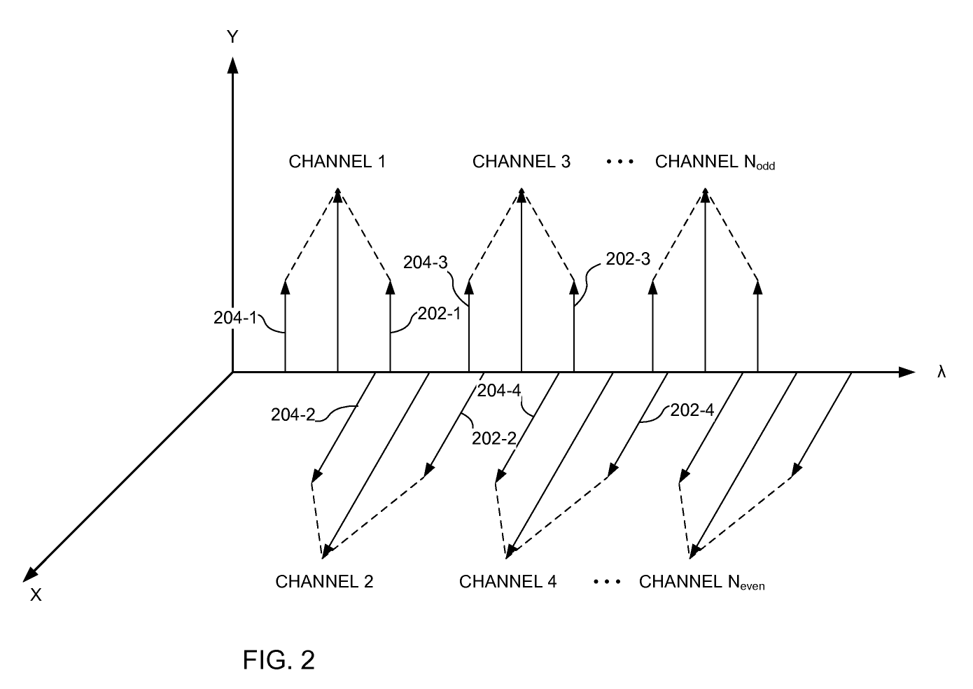

The transmitter 140 may be configured to launch output optical signals on multiple optical channels (e.g., on the transmission path 106) with a pair-wise orthogonal polarization relationship, as shown in FIG. 2. For example, optical channel 1 having wavelength λ1 is orthogonally polarized with respect to adjacent optical channel 2 having wavelength λ2. As a result of the pair-wise orthogonal polarization relationship, a first subset of channels (i.e., odd channels 1, 3, . . . N_{odd}) and a second subset of channels (i.e., even channels 2, 4, . . . Nₑᵥₑₙ) have first and second polarization states, respectively, in separate polarization axes X and Y. To transmit the channels with the pair-wise orthogonal relationship, the transmitter 140 may include a commercially available polarization beam combiner (not shown) known to those skilled in the art.

As a result of synchronous optical processing (e.g., amplitude and/or phase modulation), Fourier components or modulation sidebands may be generated around the wavelength of each of the optical channels. Each channel may include an upper modulation sideband and a lower modulation sideband. For example, channel 1 at wavelength λ1 has an upper sideband 202-1 higher than the wavelength λ1 and a lower sideband 204-1 lower than the wavelength λ1. Similarly, channel 2 at wavelength λ2 has an upper sideband 202-2 higher than the wavelength λ2 and a lower sideband 204-2 lower than the wavelength λ2. Accounting for the modulation sidebands, each channel may be associated with a range or band of wavelengths.

According to one embodiment, the channel spacing may be chosen such that the modulation sidebands do not overlap on the same polarization axis. Within the first subset of channels having the first polarization state, for example, the sidebands of adjacent optical channels do not overlap. For example, the upper sideband 202-1 associated with channel 1 does not overlap the lower sideband 204-3 associated with channel 3. Similarly, the sidebands of adjacent optical channels do not overlap within the second subset of channels having the second polarization state. For example, the upper sideband 202-2 associated with channel 2 does not overlap the lower sideband 204-4 associated with channel 4.

To ensure that the modulation sidebands do not overlap within each polarization axis, the channel spacing Δf (e.g., of channels 1, 2, 3, 4, . . . N) may based on an odd number of ½ B steps or increments where B is the line rate in gigabits per second (Gb/s). For example, in a 10 Gb/s (9.9533 Gb/s) system, forward error correction (FEC) coding may be used to provide a 12.3 Gb/s line rate. In such a system, the channel spacing may be calculated as Δf=1.5(12.3 GHz)=18.45 GHz. This results in a spectral efficiency of about (9.9533 Gb/s)/18.45 GHz=0.54(bits/s)/Hz. At a spectral efficiency of about 0.54 (bits/s)/Hz, 128 optical channels, each carrying 10 Gb/s, may be transmitted in a 19 nm bandwidth; or 256 channels, each carrying 10 Gb/s, may be transmitted in a 38 nm bandwidth, both of which fall within the Erbium C-band. Thus, spectral efficiencies may be increased in this example by selecting a channel spacing Δf of 1½ times the line rate B.

In terms of total power (i.e., without regard for polarization), the modulation sidebands of adjacent optical channels may overlap. The lower modulation sideband 204-2 associated with channel 2, for example, may overlap with the upper modulation sideband 202-1 associated with channel 1. Similarly, the lower modulation sideband 204-3 associated with channel 3 may overlap with the upper modulation sideband 202-2 associated with channel 2. Because of this overlap, the channels transmitted with a pair-wise orthogonal relationship may not be completely separated at the receiver using typical filtering techniques without causing some receiver impairments.

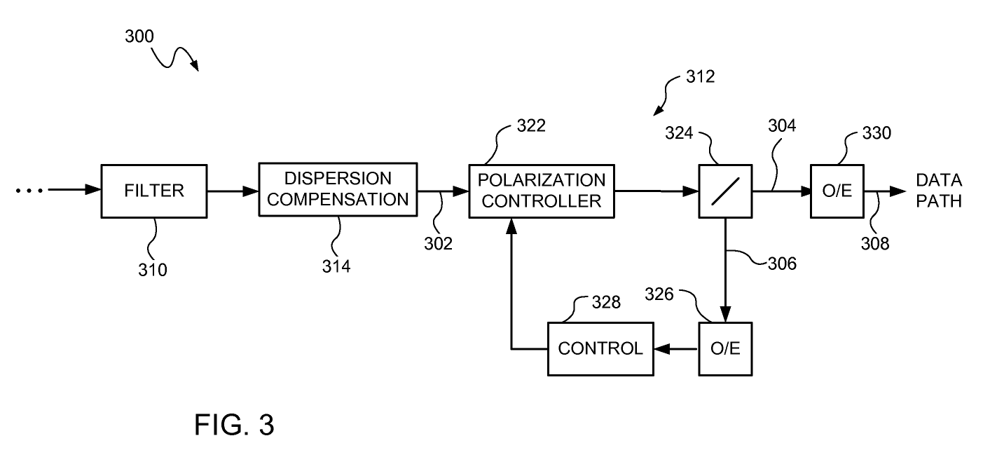

Referring to FIG. 3, an exemplary optical receiver 300, consistent with one embodiment of the present invention, includes polarization control to improve channel selectivity when optical channels are launched with a pair-wise orthogonal relationship, as described above. The receiver 300 may include a filter 310 that selects at least one channel of interest from multiple channels and a polarization control loop 312 that minimizes the power in the orthogonal polarization (i.e., a channel or a portion of a channel adjacent to and orthogonal to the selected channel). The filter 310 may be an optical band-pass filter that allows at least the band of wavelengths associated with the channel of interest to pass while preventing other wavelengths from passing, thereby dropping other channels. The receiver 300 may also include a dispersion compensation stage 314 to provide dispersion compensation at the wavelength(s) of the selected channel before the polarization control loop 312.

The polarization control loop 312 may include a polarization controller 322, such as a waveplate or electro-optic polarization controller, a polarization beamsplitter 324, an optical-to-electrical converter 326, and a control circuit 328. An optical signal 302 received on the channel selected by the filter 310 is passed to the polarization controller 322, which rotates the optical signal before the polarization beamsplitter 324. The beamsplitter 324 splits the optical signal into first and second optical components 304, 306 having different polarization states. The polarization controller 322 should orient the received optical signal 302 such that the first optical component 304 has a polarization state generally aligned or consistent with the polarization state of the selected channel and the second optical component 306 has a polarization state generally aligned or consistent with the polarization state of an adjacent channel orthogonal to the selected channel.

The first optical component 304 includes the selected channel and is passed to an optical-to-electrical (O/E) converter 330 to convert the optical signal received on the selected channel into an electrical signal on a data path 308. After the O/E converter 330, the electrical signal may be coupled to conventional detection and decoding circuitry (not shown), as is known to those skilled in the art. The second optical component 306 is converted into an electrical signal by the O/E converter 326 and is passed to the control circuit 328. In response to the electrical signal, the control circuit 328 controls the polarization controller 322 such that the power of the second optical component 306 is maximized, thereby minimizing the power of the orthogonal polarization within the first optical component 304 including the selected channel. By minimizing the power of the orthogonal polarization within the first optical component 304, the polarization control loop 312 maximizes throughput to the data path because the selected channel is effectively separated from overlapping adjacent channels. As a result, the polarization control loop 312 essentially “nulls” the orthogonal channel(s) adjacent to the selected channel. As used herein, the term “null” refers to the minimizing of the power in the adjacent orthogonal channel but does not necessarily require the power to be minimized to zero.

Although the exemplary optical receiver 300 is configured to select one channel, additional receivers similar to the optical receiver 300 may be configured to select each channel within a plurality of multiple WDM channels. Those skilled in the art will also recognize that other implementations of the receiver 300 are possible. The filter 310, for example, may be implemented as part of a demultiplexer. The dispersion compensation may be performed in other locations within the receiver or outside of the receiver. Those skilled in the art will also recognize that the control circuit 328 may be implemented in hardware, software, firmware or any combination thereof.

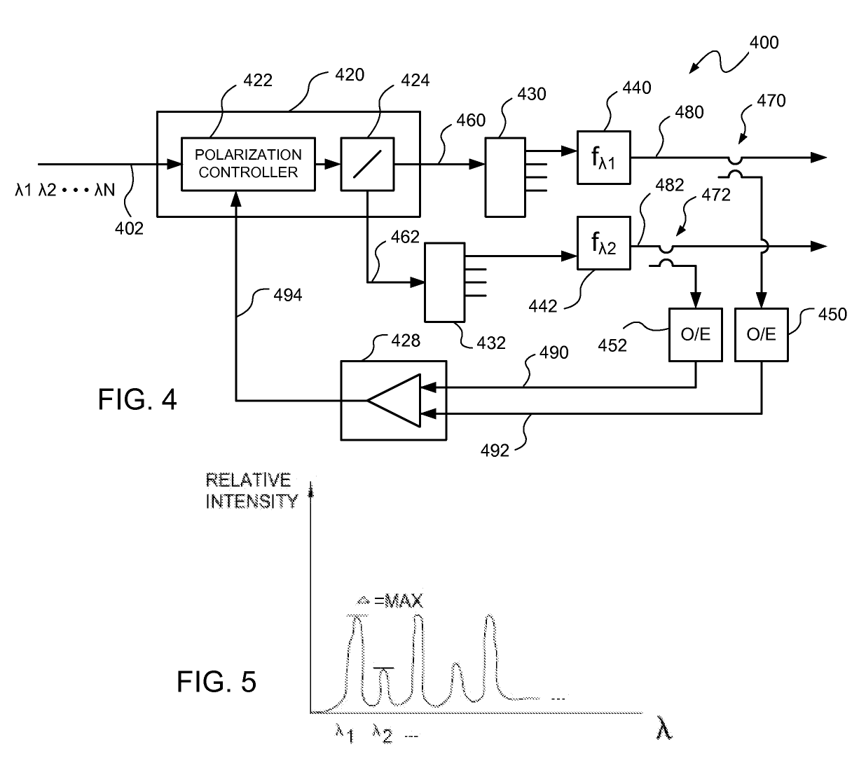

Referring to FIG. 4, another embodiment of a system 400 for nulling adjacent orthogonal optical channels is described. The system 400 may include a polarization selecting unit 420, at least one pair of channel filters 440, 442, at least one pair of optical-to-electrical converters 450, 452, and a control circuit 428. The system 400 may receive a multiplexed optical signal 402 on multiple optical channels at multiple wavelengths (λ1, λ2 . . . λN), which have been launched with a pair-wise orthogonal relationship, as described above.

The polarization selecting unit 420 is configured to separate the optical signal 402 into the polarization states of the orthogonal channels. The polarization selecting unit 420 may include a polarization controller 422 and a polarization beam splitter 424. The polarization controller 422 rotates or orients the polarization of the optical signal 402 according to a control signal received from the control circuit 428. The polarization beam splitter 424 splits the optical signal into first and second optical components 460, 462 having different polarization states. The optical filters 440, 442 receive the first and second optical components 460, 462, respectively, and select adjacent channels (e.g., a channel at wavelength λ₁ and a channel at wavelength λ₂) within the respective optical components 460, 462.

The filter 440 may be, for example, an interference filter, fiber Bragg grating or other optical filter having a high transmission characteristic associated with a particular wavelength or band of wavelengths associated with one channel (e.g., channel 1 at wavelength λ₁) and a high reflectivity characteristic associated with other wavelengths. Similarly, the filter 442 may be, for example, an interference filter, fiber Bragg grating or other optical filter having a high transmission characteristic associated with a wavelength or band of wavelengths associated with an adjacent channel (e.g., channel 2 at wavelength λ₂) and a high reflectivity characteristic associated with other wavelengths.

Although one pair of filters 440, 442 may be used for two adjacent channels (e.g., at wavelengths λ₁ and λ₂), multiple pairs of filters (not shown) may be used for multiple pairs of adjacent channels (e.g., λ₁ and λ₂, λ₃ and λ₄, λ₅ and λ₆ . . . ). The system 400 may include 1×N couplers 430, 432 to provide the first and second optical components 460, 462, respectively, to the multiple pairs of filters (not shown) associated with the multiple pairs of adjacent channels.

The system 400 may include optical taps 470, 472 to tap a portion (e.g., about 5-10%) of respective filtered optical components 480, 482 associated with the selected adjacent channels (e.g., channels at wavelengths λ₁ and λ₂). The remaining portion of the filtered optical components 480, 482 associated with the adjacent channels is passed on for detection and decoding. The tapped portions of the filtered optical components 480, 482 are supplied to the respective optical-to-electrical (O/E) converters 450, 452. The O/E converters 450, 452 (e.g., photodectors) convert the filtered optical components 480, 482 to corresponding electrical signals 490, 492. The electrical signals 490, 492 from the O/E converters 450, 452 are supplied to the control circuit 428. The control circuit 428 may include, for example, a difference amplifier circuit that receives the electrical signals 490, 492 and produces an error signal 494 to control the polarization controller 422 such that the detected power of the two adjacent channels (e.g., channel 1 at λ₁ and channel 2 at λ₂) is maximized.

The error signal 494 will thus cause the polarization controller 422 to be oriented such that the optical components 460, 462 from the beamsplitter 424 have polarization states consistent with the first and second polarization states of the channels launched with the pair-wise orthogonal relationship. When the detected power of the two adjacent channels is maximized, for example, the beamsplitter 424 produces a first optical component 460 with a polarization state consistent with the polarization state of the odd channels on the ‘Y’ axis shown in FIG. 2 and a second optical component 462 with a polarization state consistent with the polarization state of the even channels on the ‘X’ axis shown in FIG. 2. Accordingly, the adjacent orthogonal channels (including the overlapping modulation sidebands) have been effectively “nulled” in each of the optical components 460, 462. Because the adjacent channels within each of the polarization states do not overlap (e.g., as shown in FIG. 2), the filters 440, 442 may select the desired channel of interest regardless of the spectra overlap between adjacent orthogonal channels (e.g., channels 1, 2, 3, . . . N).

FIG. 5 illustrates the relative intensity of optical signals on channels 1, 2 . . . N, for example, as seen on an optical spectrum analyzer (OSA) on the input side of the filter 440. The adjacent orthogonal channels (e.g., the even channels) may be nulled when the relative intensity difference Δ between the adjacent channels (e.g., between channel 1 and 2) is maximized. In one example, the relative intensity difference may be maximized when Δ≅30 dB.

According to an alternative embodiment, a system for nulling adjacent orthogonal optical channels may control a polarization controller without converting the optical component(s) into an electrical signal. The wavelengths of adjacent channels (e.g., channels 1 and 2) within the optical component(s) may be detected (e.g., with an OSA) and the intensity difference between the adjacent channels may be determined. The polarization controller may be rotated or controlled (e.g., using hardware or software) such that the intensity difference between the adjacent channels is maximized.

Accordingly, an optical communication system, consistent with one aspect of the present invention, includes an optical transmitter configured to generate a plurality of optical channels with a pair-wise orthogonal relationship such that a first subset of the optical channels has a first polarization state and a second subset of the optical channels has a second polarization state orthogonal to the first polarization state. The optical transmitter is configured to generate the optical channels at different wavelengths and with a channel spacing such that modulation sidebands of adjacent optical channels do not overlap within each of the first and second subsets of optical channels and such that modulation sidebands of adjacent optical channels overlap within the plurality of optical channels. The optical communication system also comprises an optical receiver configured to receive at least some of the plurality of optical channels having the pair-wise orthogonal relationship, to select at least one channel of interest, and to detect an optical signal on the channel of interest. An optical transmission path may be coupled between the transmitter and the receiver.

Consistent with another aspect of the present invention, a system includes a polarization controller configured to receive an optical signal on at least one selected channel having a band of wavelengths and configured to orient a polarization of the optical signal. A polarization beamsplitter may be coupled to the polarization controller and configured to split the optical signal into first and second optical components having different polarization states. A control circuit may be coupled to the polarization controller and configured to control the polarization controller such that power of orthogonal channels adjacent to the selected channel in one of the optical components is minimized.

Consistent with a further aspect of the present invention, a method includes: receiving a plurality of optical channels having a plurality of associated wavelengths, the optical channels being generated with a pair-wise orthogonal relationship; selecting at least one channel of interest from the plurality of optical channels; minimizing power of the channels adjacent to and orthogonal to the at least one channel of interest; and detecting an optical signal on the at least one channel of interest.

While the foregoing is directed to embodiments of the present invention, other and further embodiments of the invention may be devised without departing from the basic scope thereof, and the scope thereof is determined by the claims that follow.

What is claimed is:

1. An optical communication system comprising:
an optical transmitter configured to generate a plurality of optical channels with a pair-wise orthogonal relationship such that a first subset of said optical channels has a first polarization state and a second subset of said optical channels has a second polarization state orthogonal to said first polarization state, wherein said optical transmitter is configured to generate said optical channels at different wavelengths and with a channel spacing such that modulation sidebands of adjacent optical channels do not overlap within each of said first and second subsets of optical channels and such that modulation sidebands of adjacent optical channels overlap within said plurality of optical channels;
an optical receiver configured to receive at least some of said plurality of optical channels having said pair-wise orthogonal relationship, to select at least one channel of interest, and to detect an optical signal on said channel of interest; and
an optical transmission path coupled between said transmitter and said receiver.

2. The optical communication system of claim 1, wherein said channel spacing between optical channels within said plurality of optical channels is an odd number of ½ B steps, where B is a line rate of said transmitter.

3. The optical communication system of claim 1, wherein said channel spacing between optical channels within said plurality of optical channels is 1.5B, where B is a line rate of said transmitter.

4. The optical communication system of claim 1 wherein said receiver comprises a polarization control loop configured to null orthogonal channels adjacent to said channel of interest prior to detecting said optical signal on said channel of interest.

5. The optical communication system of claim 1, wherein said receiver comprises:
a polarization controller configured to orient a polarization of received optical channels having said pair-wise orthogonal relationship;
a polarization beam splitter coupled to said polarization controller and configured to split said received optical channels into first and second optical components having different polarization states; and
a polarization control circuit configured to control orientation of said polarization controller such that said polarization states of said optical components are consistent with said first and second polarization states of said first and second subsets of channels.

6. The optical communication system of claim 5 wherein said receiver further comprises at least one filter configured to select said at least one channel of interest.

7. The optical communication system of claim 5 wherein said first optical component includes said channel of interest, wherein said receiver further comprises at least one optical-to-electrical converter configured to convert at least said second optical component into an electrical signal, and wherein said control circuit is configured to provide a control signal in response to said electrical signal such that power of said second optical component is maximized.

8. The optical communication system of claim 5 wherein said receiver further comprises a pair of filters configured to receive and filter respective said first and second optical components such that respective adjacent orthogonal channels are selected.

9. The optical communication system of claim 8 further comprising a pair of optical-to-electrical converters configured to receive respective filtered first and second optical components from said pair of filters and to convert said filtered optical components into corresponding first and second electrical signals, and wherein said control circuit is configured to receive said first and second electrical signals and to provide an error signal to control said polarization controller such that detected power in each of said electrical signals is maximized.

10. The optical communication system of claim 1, wherein said transmitter further comprises:
a light source;
a data modulator optically coupled to said light source;
an amplitude modulator optically coupled to said data modulator; and
a phase modulator optically coupled to said amplitude modulator.

11. A system comprising:
a polarization controller configured to receive an optical signal on at least one selected channel having a band of wavelengths and configured to orient a polarization of said optical signal;
a polarization beamsplitter coupled to the polarization controller and configured to split said optical signal into first and second optical components having different polarization states; and
a control circuit coupled to the polarization controller and configured to control said polarization controller such that power of orthogonal channels adjacent to said selected channel in one of said optical components is minimized.

12. The system of claim 11 further comprising a filter configured to select said selected channel from a plurality of channels.

13. The system of claim 11 further comprising at least optical-to-electrical converter configured to convert at least said second optical component into an electrical signal, and wherein said control circuit is configured to provide a control signal in response to said electrical signal such that power of said second optical component is maximized.

14. The system of claim 11 further comprising a pair of filters configured to receive and filter respective said first and second optical components such that respective adjacent channels are selected.

15. The system of claim 14 further comprising a pair of optical-to-electrical converters configured to receive respective filtered first and second optical components from said pair of filters and to convert said filtered optical components into corresponding first and second electrical signals, and wherein said control circuit is configured to receive said first and second electrical signals and to provide an error signal to control said polarization controller such that detected power in each of said electrical signals is maximized.

16. A method comprising:
receiving a plurality of optical channels having a plurality of associated wavelengths, said optical channels being generated with a pair-wise orthogonal relationship;
selecting at least one channel of interest from said plurality of optical channels;
minimizing power of said channels adjacent to and orthogonal to said at least one channel of interest; and
detecting an optical signal on said at least one channel of interest.

17. The method of claim 16, wherein a first subset of said optical channels has a first polarization state and a second subset of said optical channels has a second polarization state orthogonal to said first polarization state, and wherein said optical channels are generated at different wavelengths and with a channel spacing such that modulation sidebands of adjacent optical channels in each of said first and second subsets of optical channels do not overlap and modulation sidebands of adjacent optical channels of said plurality of optical channels overlap.

18. The method of claim 16 wherein minimizing power of said channels adjacent to and orthogonal to said channel of interest comprises:
orienting polarization of said optical signal on said channel of interest;
splitting said optical signal on said channel of interest into first and second optical components having different polarization states;
controlling orientation of said polarization of said optical signal such that said different polarization states are aligned with first and second polarization states of said channels with said pair-wise orthogonal relationship.

19. The method of claim 18 further comprising filtering said first and second optical components to select respective adjacent channels.

20. The method of claim 19 further comprising converting filtered said first and second optical components into electrical signals, and wherein orientation of said polarization is controlled by providing an error signal in response to said electrical signals such that polarization is oriented to maximize power of said electrical signals.
